(19) United States
(12) Patent Application Publication
(10) Pub. No.: US 2026/0046178 A1
(43) Pub. Date: Feb. 12, 2026

(54) METHOD FOR DETERMINING EQUALIZER COEFFICIENTS

(71) Applicant: REALTEK SEMICONDUCTOR CORPORATION, Hsinchu (TW)

(72) Inventors: Tsung-En WU, Hsinchu (TW); Hua-Lun PI, Hsinchu (TW); Han Yang, Hsinchu (TW); Ting-Yang LIN, Hsinchu (TW)

(21) Appl. No.: 19/260,893

(22) Filed: Jul. 7, 2025

(30) Foreign Application Priority Data
Aug. 7, 2024 (TW) 113129545

(51) Int. Cl. H04L 25/03

(52) U.S. Cl. CPC H04L 25/03267; H04L 25/03057; H04L 2025/0349

(57) ABSTRACT

A method for determining equalizer coefficients includes the following operations: (a) setting low-frequency equalizer coefficients of a low-frequency equalizer circuit; (b) establishing a network connection via the low-frequency equalizer circuit and a decision feedback equalizer circuit, in which the decision feedback equalizer circuit operates according to an output of the low-frequency equalizer circuit; (c) recording a sum of absolute values of decision feedback equalizer coefficients of the decision feedback equalizer circuit and a signal-to-noise ratio; (d) repeatedly performing the operations (a) to (c) to obtain sums of absolute values and signal-to-noise ratios; (e) selecting a first sum of absolute values from sums of absolute values according to a predetermined threshold value and signal-to-noise ratios; and (f) setting low-frequency equalizer coefficients as a value combination corresponding to the first sum of absolute values.

### BACKGROUND OF THE INVENTION

### 1. Field of the Invention

The present disclosure relates to a communication device, and more particularly, to a low-frequency equalizer circuit that is configured to reduce error propagation of a decision feedback equalizer circuit, and a method for determining equalizer coefficients thereof.

### 2. Description of Related Art

In some related approaches, a decision feedback equalizer circuit in a receiver is utilized to compensate for post-cursor inter-symbol interference of an input signal. However, if an input of the decision feedback equalizer circuit is erroneous (e.g., a decision error of a comparator), the error is fed back to the comparator via the decision feedback equalizer circuit, thereby affecting a subsequent decision made by the comparator. The above phenomenon may be referred to as error propagation. If equalizer coefficients of the decision feedback equalizer circuit are relatively large, the above error is amplified, and the risk of decision errors in the comparator becomes higher.

### SUMMARY OF THE INVENTION

In some aspects, an object of the present disclosure is to, but not limited to, provide a low-frequency equalizer circuit that is configured to reduce error propagation of a decision feedback equalizer circuit, and a method for determining equalizer coefficients thereof, so as to make an improvement to the prior art.

In some aspects, a method for determining equalizer coefficients, executed by a test system, the method for determining equalizer coefficients includes the following operations: (a) setting a plurality of low-frequency equalizer coefficients of a low-frequency equalizer circuit; (b) establishing a network connection via the low-frequency equalizer circuit and a decision feedback equalizer circuit, in which the decision feedback equalizer circuit operates according to an output of the low-frequency equalizer circuit; (c) recording a sum of absolute values of a plurality of decision feedback equalizer coefficients of the decision feedback equalizer circuit and a signal-to-noise ratio; (d) repeatedly performing the operations (a) to (c) to obtain a plurality of sums of absolute values and a plurality of signal-to-noise ratios; (e) selecting a first sum of absolute values from the plurality of sums of absolute values according to a predetermined threshold value and the plurality of signal-to-noise ratios; and (f) setting the plurality of low-frequency equalizer coefficients as a value combination corresponding to the first sum of absolute values.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1A illustrates a schematic diagram of a receiver according to some embodiments of this disclosure.

FIG. 1B illustrates a schematic diagram of the digital signal processor circuit in FIG. 1A according to some embodiments of this disclosure.

FIG. 2A illustrates a schematic diagram of the low-frequency equalizer circuit in FIG. 1B according to some embodiments of this disclosure.

FIG. 2B illustrates a schematic diagram of the low-frequency equalizer circuit in FIG. 1B according to some embodiments of this disclosure.

FIG. 3 illustrates a schematic diagram of the decision feedback equalizer circuit in FIG. 1B according to some embodiments of this disclosure.

FIG. 4 illustrates a flowchart of a method for determining equalizer coefficients according to some embodiments of this disclosure.

FIG. 5 illustrates a schematic diagram of heat map data generated according to the sum of absolute values of the decision feedback equalizer coefficients and the signal-to-noise ratios obtained in an operation in FIG. 4 according to some embodiments of this disclosure.

FIG. 6 illustrates a schematic diagram of a circuit model for executing the method 400 for determining equalizer coefficients of FIG. 4 according to some embodiments of this disclosure.

FIG. 7 illustrates a schematic diagram of a test system for the method for determining equalizer coefficients of FIG. 4 according to some embodiments of this disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuit” may indicate an object, which is formed with one or more transistors and/or one or more active/passive elements according to a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, similar/identical elements in various figures are designated with the same reference number.

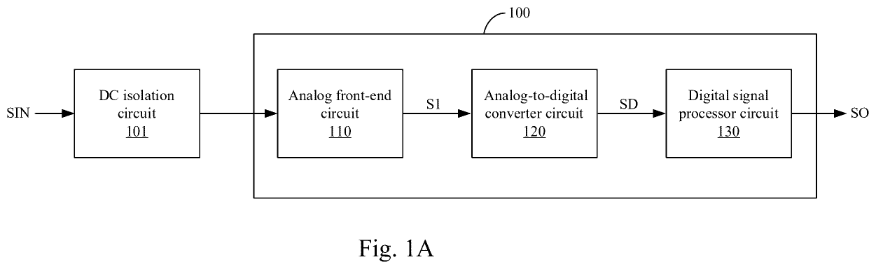

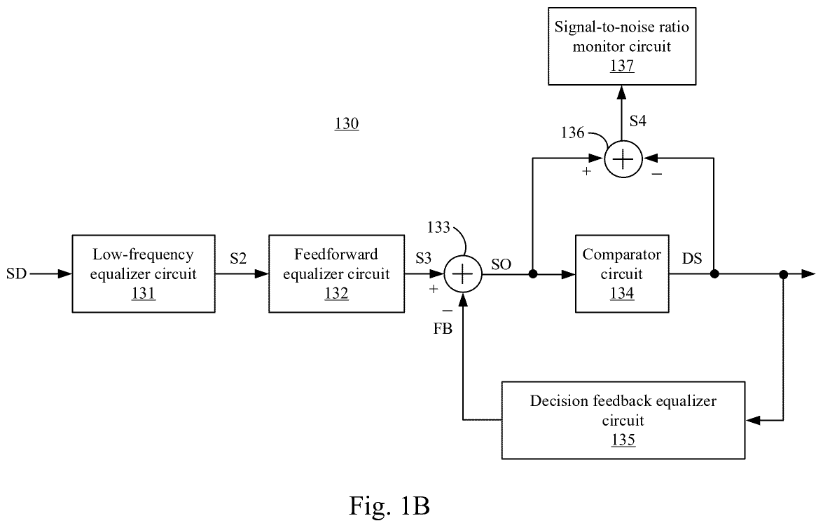

FIG. 1A illustrates a schematic diagram of a receiver 100 according to some embodiments of this disclosure. In some embodiments, the receiver 100 may be applied in an Ethernet system. For example, the receiver 100 may receive an input signal SIN via a DC isolation circuit 101. In some embodiments, the DC isolation circuit 101 may be, but is not limited to, a DC isolation circuit in an Ethernet port, and may include circuit component(s) such as coupling capacitor(s) and/or network transformer(s).

The receiver 100 includes an analog front-end circuit 110, an analog-to-digital converter circuit 120, and a digital signal processor circuit 130. The analog front-end circuit 110 is configured to receive the input signal SIN and perform amplification and filtering on the input signal SIN to generate a signal S1. The analog-to-digital converter circuit 120 is configured to convert the signal S1 into a digital signal SD. The digital signal processor circuit 130 is configured to process the digital signal SD to generate an output signal SO. In some embodiments, the digital signal processor circuit 130 is configured to compensate for the effect caused by a channel on the input signal SIN. For example, the digital signal processor circuit 130 may utilize channel equalization technique(s) to compensate for the effect of the channel on the input signal SIN (e.g., including distortion such as inter-symbol interference (ISI)). In some embodiments, the aforementioned channel includes the entire signal path that the input signal SIN passes through (e.g., including the DC isolation circuit 101 and network cables, etc.).

FIG. 1B illustrates a schematic diagram of the digital signal processor circuit 130 in FIG. 1A according to some embodiments of this disclosure. The digital signal processor circuit 130 includes a low-frequency equalizer circuit 131, a feedforward equalizer circuit 132, a subtractor circuit 133, a comparator (slicer) circuit 134, a decision feedback equalizer circuit 135, a subtractor circuit 136, and a signal-to-noise ratio monitor circuit 137.

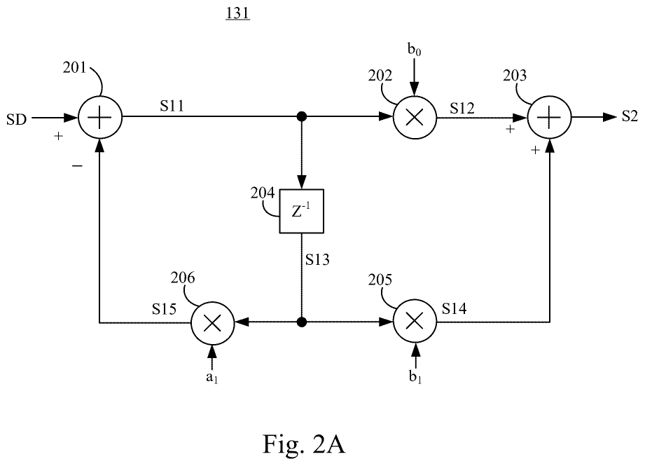

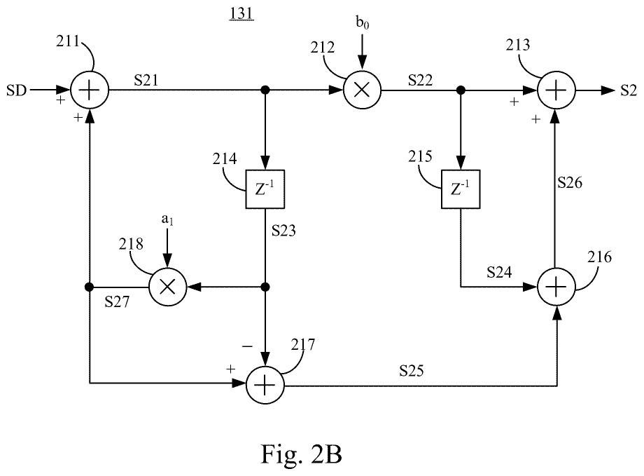

The low-frequency equalizer circuit 131 is configured to generate a signal S2 according to the digital signal SD. In some embodiments, the low-frequency equalizer circuit 131 is mainly responsible for compensating attenuation of low-frequency components in the input signal SIN caused by the DC isolation circuit 101, thereby reducing the likelihood of error propagation in the decision feedback equalizer circuit 135. In some embodiments, the low-frequency equalizer circuit 131 may be, but is not limited to, a shelving filter circuit. Some configuration examples of the low-frequency equalizer circuit 131 will be given with reference to FIG. 2A and FIG. 2B.

The feedforward equalizer circuit 132 generates a signal S3 according to the signal S2. In some embodiments, the feedforward equalizer circuit 132 is mainly responsible for eliminating pre-cursor inter-symbol interference and part of the post-cursor inter-symbol interference in the input signal SIN. In some embodiments, the feedforward equalizer circuit 132 may be implemented with, but is not limited to, a finite impulse response filter circuit.

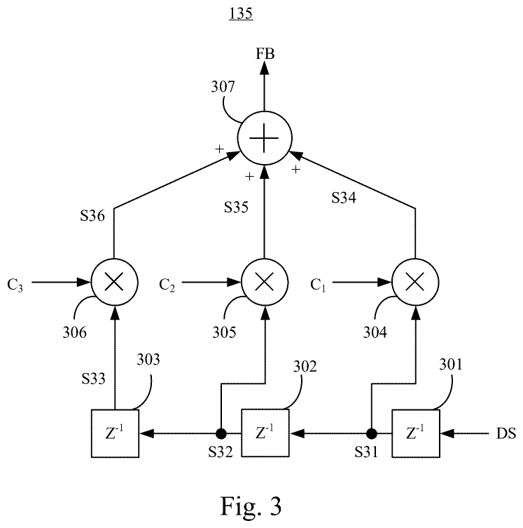

The subtractor circuit 133 is configured to subtract a feedback signal FB from the signal S3 to generate an output signal SO. The comparator circuit 134 is configured to generate a decision signal DS according to the output signal SO. The decision feedback equalizer circuit 135 is configured to generate the feedback signal FB according to the decision signal DS. In some embodiments, the decision feedback equalizer circuit 135 is mainly responsible for eliminating remaining post-cursor inter-symbol interference in the input signal SIN. Some configuration examples of the decision feedback equalizer circuit 135 will be given with reference to FIG. 3.

The subtractor circuit 136 is configured to subtract the decision signal DS from the output signal SO to generate a signal S4. In some embodiments, the signal S4 may be utilized to indicate a comparator error of the comparator circuit 134. An absolute value of the comparator error may be utilized to indicate the signal-to-noise ratio of the output signal SO (or may be utilized to indicate the signal-to-noise ratio of the entire digital signal processor circuit 130 or any circuit thereof). The signal-to-noise ratio monitor circuit 137 is configured to monitor the signal-to-noise ratio based on the signal S4. For example, the signal-to-noise ratio monitor circuit 137 may compute a function such as the absolute value or the square of the signal S4 to estimate the signal-to-noise ratio.

FIG. 2A illustrates a schematic diagram of the low-frequency equalizer circuit 131 in FIG. 1B according to some embodiments of this disclosure. In some embodiments, as described above, the low-frequency equalizer circuit 131 may be a shelving filter circuit. In some embodiments, a frequency response of the low-frequency equalizer circuit 131 may be set as a transfer function of a first-order infinite impulse response filter of Equation (1):

$$F ( z ) = \frac{{b}_{0} + {b}_{1} {z}^{- 1}}{1 + {a}_{1} {z}^{- 1}} \qquad ( 1 )$$

In Equation (1), b₀, b₁, and a₁ are low-frequency equalizer coefficients of the low-frequency equalizer circuit 131. Furthermore, referring to design specifications of a shelving filter circuit, when a gain G and a corner frequency ω_{c} of the low-frequency equalizer circuit 131 are known, the low-frequency equalizer coefficients b₀, b₁, and a₁ may be further derived based on Equation (2).

$$b {}_{0}^{″} = G \cdot tan ( {ω}_{c} / 2 ) + \sqrt{G} \qquad ( 2 )$$

$${b}_{1}^{″} = G \cdot tan ( {ω}_{c} / 2 ) - \sqrt{G}$$

$${a}_{0}^{″} = tan ( {ω}_{c} / 2 ) + \sqrt{G}$$

$${a}_{1}^{″} = tan ( {ω}_{c} / 2 ) - \sqrt{G} ⇒ {b}_{0} = {b}_{0}^{″} / {a}_{0}^{″} \cdot {b}_{1} = {b}_{1}^{″} / {a}_{0}^{″} \cdot {a}_{1} = {a}_{1}^{″} / {a}_{0}^{″}$$

Accordingly, in some embodiments, the low-frequency equalizer circuit 131 may be implemented directly based on Equation (1). As shown in FIG. 2A, the low-frequency equalizer circuit 131 may include a subtractor circuit 201, a multiplier circuit 202, an adder circuit 203, a delay circuit 204, a multiplier circuit 205, and a multiplier circuit 206. The subtractor circuit 201 is configured to subtract a signal S15 from the digital signal SD to generate a signal S11. The multiplier circuit 202 is configured to multiply the signal S11 by the low-frequency equalizer coefficient b₀ to generate a signal S12. The adder circuit 203 is configured to add the signal S12 to a signal S14 to generate a signal S2 (i.e., the output of the low-frequency equalizer circuit 131). The delay circuit 204 is configured to delay the signal S11 to generate a signal S13. The multiplier circuit 205 is configured to multiply the signal S13 by the low-frequency equalizer coefficient b1 to generate the signal S14. The multiplier circuit 206 is configured to multiply the signal S13 by the low-frequency equalizer coefficient a₁ to generate the signal S15.

FIG. 2B illustrates a schematic diagram of the low-frequency equalizer circuit 131 in FIG. 1B according to some embodiments of this disclosure. In some embodiments, it may be further derived that the low-frequency equalizer coefficient b₁ in Equation (2) may be expressed as a combination of two other low-frequency equalizer coefficients b₀ and a₁, and the mathematical relationship may be expressed as Equation (3):

$$\begin{matrix}{b}_{1} = \frac{b {}_{1}^{″}}{a {}_{0}^{″}} \\ = \frac{G \cdot tan ( {ω}_{c} / 2 ) + \sqrt{G}}{{a}_{0}^{″}} \\ = \frac{G \cdot tan ( {ω}_{c} / 2 ) - \sqrt{G} + 2 \sqrt{G}}{{a}_{0}^{″}} \\ = \frac{[ G \cdot tan ( {ω}_{c} / 2 ) - \sqrt{G} ] + [ tan ( {ω}_{c} / 2 ) + \sqrt{G} - [ tan ( {ω}_{c} / 2 ) - \sqrt{G} ]}{{a}_{0}^{″}} \\ = \frac{{b}_{0}^{″} + {a}_{1}^{″} - {a}_{0}^{″}}{{a}_{0}^{″}} \\ = {b}_{0} + {a}_{1} - 1\end{matrix} \qquad ( 3 )$$

Accordingly, unlike FIG. 2A, when the low-frequency equalizer circuit 131 is implemented based on Equation (3), as shown in FIG. 2B, the low-frequency equalizer circuit 131 may include an adder circuit 211, a multiplier circuit 212, an adder circuit 213, a delay circuit 214, a delay circuit 215, an adder circuit 216, a subtractor circuit 217, and a multiplier circuit 218. The adder circuit 211 is configured to add the digital signal SD and a signal S27 to generate a signal S21. The multiplier circuit 212 multiplies the low-frequency equalizer coefficient b₀ and the signal S21 to generate a signal S22. The adder circuit 213 adds the signal S22 and a signal S26 to generate a signal S2 (i.e., the output of the low-frequency equalizer circuit 131). The delay circuit 214 delays the signal S21 to generate a signal S23. The delay circuit 215 delays the signal S22 to generate a signal S24. The adder circuit 216 adds the signal S24 and a signal S25 to generate the signal S26. The subtractor circuit 217 subtracts the signal S23 from a signal S27 to generate the signal S25. The multiplier circuit 218 multiplies the signal S23 by the low-frequency equalizer coefficient a1 to generate the signal S27.

Compared with the circuit configuration of FIG. 2A, the circuit configuration of FIG. 2B reduces one multiplier circuit and additionally uses two adder circuits. Since, in actual implementation, an area of a multiplier circuit is significantly larger than an area of two adder circuits, the circuit configuration of FIG. 2B may further reduce the overall required circuit area, thereby saving circuit cost.

FIG. 3 illustrates a schematic diagram of the decision feedback equalizer circuit 135 in FIG. 1B according to some embodiments of this disclosure. In some embodiments, the decision feedback equalizer circuit 135 may be an infinite impulse response (IIR) filter circuit with taps. For example, as shown in FIG. 3, the decision feedback equalizer circuit 135 includes a delay circuit 301, a delay circuit 302, a delay circuit 303, a multiplier circuit 304, a multiplier circuit 305, a multiplier circuit 306, and an adder circuit 307. The delay circuit 301 is configured to delay the decision signal DS to generate a signal S31. The delay circuit 302 is configured to delay the signal S31 to generate a signal S32. The delay circuit 303 is configured to delay the signal S32 to generate a signal S33. The multiplier circuit 304 is configured to multiply a decision feedback equalizer coefficient C1 by the signal S31 to generate a signal S34. The multiplier circuit 305 is configured to multiply a decision feedback equalizer coefficient C2 by the signal S32 to generate a signal S35. The multiplier circuit 306 is configured to multiply a decision feedback equalizer coefficient C3 by the signal S33 to generate a signal S36. The adder circuit 307 is configured to add the signals S34, S35, and S36 to generate the feedback signal FB.

In some embodiments, values of the decision feedback equalizer coefficients C1 to C3 of the decision feedback equalizer circuit 135 may be determined by an additional adaptive control mechanism (not shown) to match a current channel response. In the example of FIG. 3, the decision feedback equalizer circuit 135 is an IIR filter circuit with three taps, which utilizes three feedback paths to generate the feedback signal FB. In practical applications, if the comparator circuit 134 in FIG. 1B makes an incorrect decision, the error propagates through these feedback paths and affects a subsequent signal, thereby influencing the next decision of the comparator circuit 134. If the next decision of the comparator circuit 134 is again erroneous due to this influence, the error may be considered as resulting from a previous decision error of the comparator circuit 134 and caused by the decision feedback equalizer circuit 135 (referred to as error propagation). In other words, if a previous decision made by the comparator circuit 134 is erroneous, an error corresponding to the decision signal DS is further propagated to the comparator circuit 134 through multiplication and addition operations performed by the decision feedback equalizer circuit 135. Generally, as the values of the decision feedback equalizer coefficients C1 to C3 increase, the aforementioned error is amplified accordingly, which increases the probability of an incorrect next decision by the comparator circuit 134. Therefore, in order to reduce error propagation, it is preferable that the sum of absolute values of the decision feedback equalizer coefficients C1 to C3 be as small as possible.

However, as described above, in order to comply with electrical isolation requirements in communication standards, the input signal SIN is input to the receiver 100 via the DC isolation circuit 101. Due to the high-pass response of the DC isolation circuit 101, low-frequency components in the input signal SIN are attenuated, which results in more post-cursor inter-symbol interference. To compensate for such attenuation, the decision feedback equalizer coefficients C1 to C3 typically converge to larger values, which instead increases the probability of error propagation. Therefore, by using the low-frequency equalizer circuit 131 to pre-compensate for the attenuation caused by the DC isolation circuit 101, the decision feedback equalizer coefficients C1 to C3 may be reduced. On the other hand, the plurality of low-frequency equalizer coefficients b₀, b₁, and a₁ used by the low-frequency equalizer circuit 131 may be further determined according to the sum of absolute values of the decision feedback equalizer coefficients C1 to C3, so as to minimize the sum of absolute values of the decision feedback equalizer coefficients C1 to C3. In this way, the influence of post-cursor inter-symbol interference may be reduced, and the risk of error propagation may also be reduced.

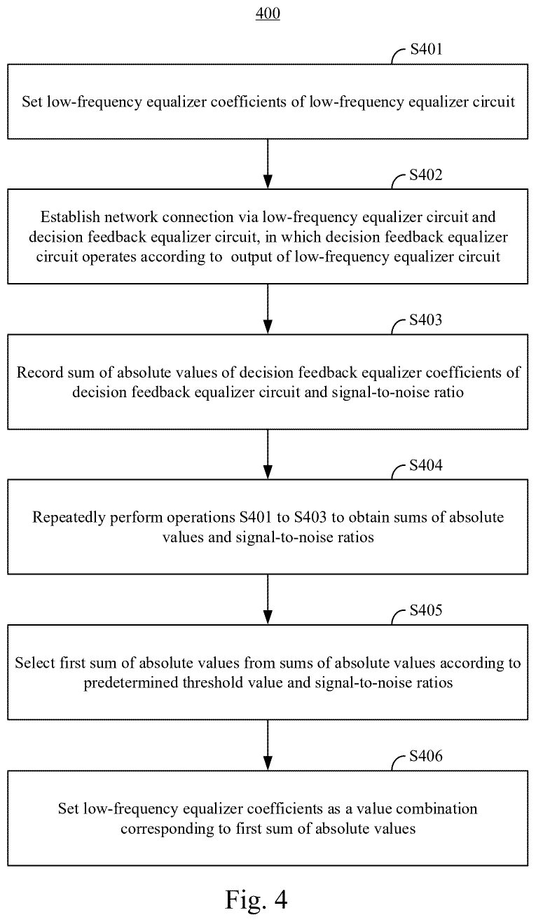

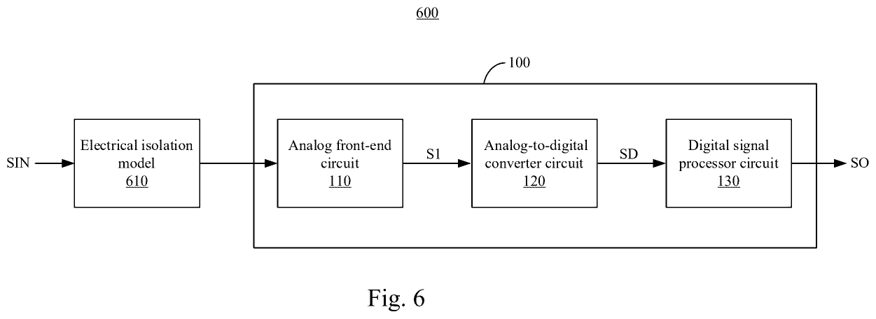

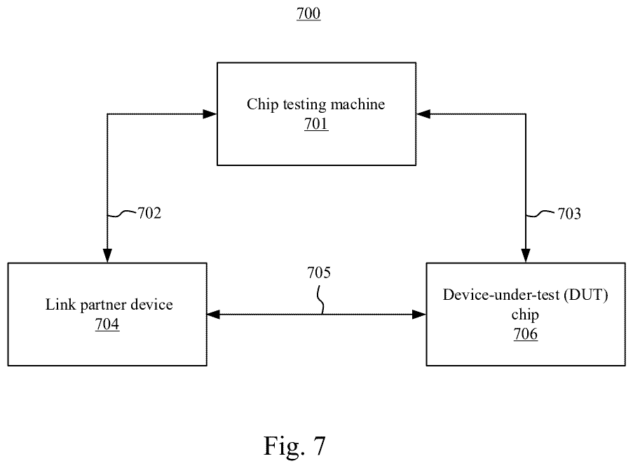

FIG. 4 illustrates a flowchart of a method 400 for determining equalizer coefficients according to some embodiments of this disclosure. In some embodiments, the method 400 for determining equalizer coefficients may be used to determine the low-frequency equalizer coefficients b₀, b₁, and a₁ of FIG. 2A or the low-frequency equalizer coefficients b₀ and a₁ of FIG. 2B. In some embodiments, the method 400 for determining equalizer coefficients may be executed by a test system. Configuration examples of the test system will be described later with reference to FIG. 6 or FIG. 7.

In operation S401, low-frequency equalizer coefficients of the low-frequency equalizer circuit are set. For example, a gain G and a corner frequency ω_{c} of the low-frequency equalizer circuit 131 may be set, and the corresponding low-frequency equalizer coefficients b₀, b₁, and a₁ (or the low-frequency equalizer coefficients b₀ and a₁) may be set as a corresponding coefficient combination according to the aforementioned Equation (2) and/or Equation (3).

In operation S402, a network connection is established via the low-frequency equalizer circuit and the decision feedback equalizer circuit, in which the decision feedback equalizer circuit operates according to an output of the low-frequency equalizer circuit.

In some embodiments, at a circuit design stage, a circuit simulation tool (e.g., but not limited to, HSPICE, MATLAB, etc.) may be executed by the test system to operate a circuit model corresponding to the receiver 100, so as to establish a virtual network connection. In other embodiments, at a chip measurement stage, the test system may connect a device-under-test (DUT) chip including the receiver 100 to a link partner device via a physical network cable to establish a network connection between them, wherein the DUT chip includes the low-frequency equalizer circuit and the decision feedback equalizer circuit. In some embodiments, the network connection in operation S402 may be, but is not limited to, an Ethernet connection.

In operation S403, a sum of absolute values of the decision feedback equalizer coefficients of the decision feedback equalizer circuit and a signal-to-noise ratio are recorded.

As described above, the decision feedback equalizer coefficients C1 to C3 of the decision feedback equalizer circuit may be determined by an adaptive mechanism. Accordingly, after the network connection is established, the decision feedback equalizer coefficients C1 to C3 may converge to stable values through the adaptive mechanism during a training phase of the network connection. Under such conditions, a sum of absolute values of the decision feedback equalizer coefficients C1 to C3 (corresponding to the low-frequency equalizer coefficients set in operation S401) may be obtained, and a corresponding signal-to-noise ratio may be detected by the signal-to-noise ratio monitor circuit 137.

In operation S404, operations S401 to S403 are repeatedly performed to obtain sums of absolute values and signal-to-noise ratios. For example, after recording a first sum of absolute values and its corresponding signal-to-noise ratio, operation S401 may be performed again to change the gain G and the corner frequency ω_{c} of the low-frequency equalizer circuit 131, thereby updating the low-frequency equalizer coefficients b₀, b₁, and a₁ (or the low-frequency equalizer coefficients b₀ and a₁) of the low-frequency equalizer circuit 131, and then operations S402 and S403 are executed to record a second sum of absolute values and its corresponding signal-to-noise ratio. In this manner, the gain G and the corner frequency ω_{c} of the low-frequency equalizer circuit 131 may be gradually adjusted to iteratively update the low-frequency equalizer coefficients b₀, b₁, and a₁ (or the low-frequency equalizer coefficients b₀ and a₁), and accordingly, the sum of absolute values of the decision feedback equalizer coefficients C to C3 and the corresponding signal-to-noise ratios may be obtained. In some embodiments, the above operations may be regarded as a brute-force algorithm for exhaustively recording the information of the sum of absolute values of the decision feedback equalizer coefficients C1 to C3 and the signal-to-noise ratios corresponding to all value combinations of the low-frequency equalizer coefficients b₀, b₁, and a₁ within a certain range.

In operation S405, a first sum of absolute values is selected from the sums of absolute values according to a predetermined threshold value and the signal-to-noise ratios. In operation S406, the low-frequency equalizer coefficients are set as a value combination corresponding to the first sum of absolute values.

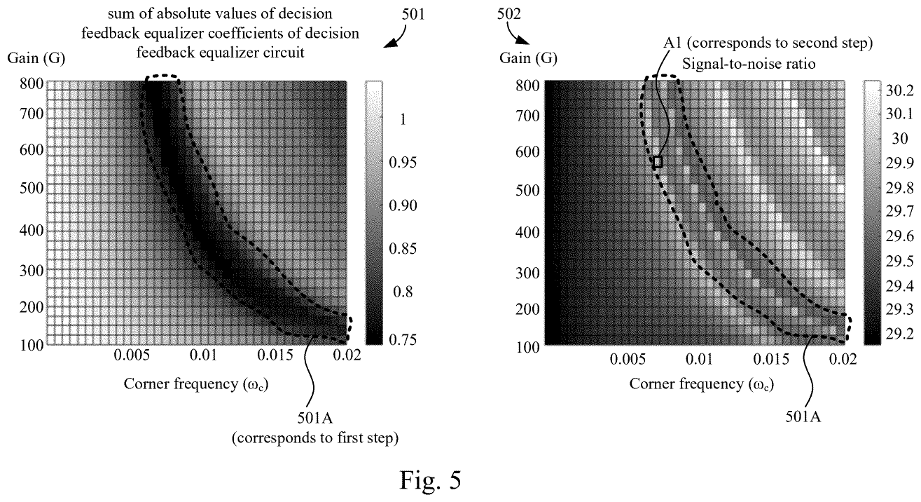

To illustrate operations S405 and S406, reference is made to FIG. 5. FIG. 5 illustrates a schematic diagram of heat map data 501 and 502 generated according to the sum of absolute values of the decision feedback equalizer coefficients C1 to C3 and the signal-to-noise ratios obtained in operation S405 according to some embodiments of this disclosure. In some embodiments, the sums of absolute values of the decision feedback equalizer coefficients C1 to C3 obtained in operation S405 may be recorded as the heat map data 501, and the signal-to-noise ratios obtained in operation S405 may be recorded as the heat map data 502.

In the heat map data 501 and the heat map data 502, the horizontal axis represents the corner frequency ω_{c} of the low-frequency equalizer circuit 131, and the vertical axis represents the gain G of the low-frequency equalizer circuit 131. In the heat map data 501, the larger the sum of absolute values of the decision feedback equalizer coefficients C1 to C3, the lighter the corresponding color. Similarly, in the heat map data 502, the higher the signal-to-noise ratio, the lighter the corresponding color.

In some embodiments, operation S405 may include a first step and a second step. In the first step, at least one second sum of absolute values that is not greater than the predetermined threshold value is selected from the sums of absolute values. In the second step, the first sum of absolute values is selected from the at least one second sum of absolute values according to the signal-to-noise ratios, wherein the first sum of absolute values is the one having a highest signal-to-noise ratio among the at least one second sum of absolute values.

For example, if the predetermined threshold value is 0.8, a region 501A not greater than the predetermined threshold value may be identified in the heat map data 501 (corresponding to the aforementioned first step). In other words, any sum of absolute values within the region 501A is not greater than the predetermined threshold. Then, the same region in the heat map data 502 may be designated as the region 501A, and a sum of absolute values A1, which has the highest signal-to-noise ratio in the sums of absolute values in the region 501A (i.e., the aforementioned at least one second sum of absolute values), may be found (corresponding to the aforementioned second step). As a result, based on the gain G and the corner frequency ω_{c} corresponding to the sum of absolute values A1 and the aforementioned Equation (2) or Equation (3), a corresponding value combination of the low-frequency equalizer coefficients b₀, b₁, and a₁ (or the low-frequency equalizer coefficients b₀ and a₁) may be obtained, and accordingly, the low-frequency equalizer coefficients b₀, b₁, and a₁ (or the low-frequency equalizer coefficients b₀ and a₁) are set as the value combination. The value combination of the low-frequency equalizer coefficients obtained through the above operation may make the sum of absolute values of the decision feedback equalizer coefficients C1 to C3 not exceed the predetermined threshold value and provide better signal-to-noise ratio. Accordingly, the risk of decision errors of the comparator circuit 134 may be reduced, and overall signal quality may be maintained.

Operations in the method 400 for determining equalizer coefficients include exemplary operations, but the operations in the method 400 for determining equalizer coefficients are not necessarily performed in the order described above. Operations in the method 400 for determining equalizer coefficients may be added, replaced, changed order, and/or eliminated, or one or more operations in the method 400 for determining equalizer coefficients may be executed simultaneously or partially simultaneously as appropriate, in accordance with the spirit and scope of various embodiments of the present disclosure.

FIG. 6 illustrates a schematic diagram of a circuit model 600 for executing the method 400 for determining equalizer coefficients of FIG. 4 according to some embodiments of this disclosure. As described above, in different embodiments, the operations in the method 400 for determining equalizer coefficients may be executed at a circuit design stage or executed by a test system at a chip measurement stage. At the circuit design stage, the aforementioned test system may be a general-purpose computer or workstation having a circuit simulation tool, which may establish the aforementioned virtual network connection by executing the circuit simulation tool according to circuit description data corresponding to the circuit model 600 (e.g., but not limited to, netlist files). In some embodiments, most of the circuits in the circuit model 600 correspond to most of the circuits in the receiver 100 of FIG. 1A, and thus will not be redundantly described here. On the other hand, to more accurately evaluate the impact of the DC isolation circuit 101 and the actual channel, the circuit model 600 further includes an electrical isolation model 610. In some embodiments, the input signal SIN may be transmitted to the low-frequency equalizer circuit 131 via the electrical isolation model 610 to establish the aforementioned network connection. In this way, the influence of the DC isolation circuit 101 and the actual channel on the input signal SIN may be more accurately considered.

In some embodiments, a circuit behavior of the electrical isolation model 610 is to operate as the aforementioned DC isolation circuit 101. In some embodiments, the electrical isolation model 610 may operate as a high-pass filter circuit. In some embodiments, the electrical isolation model 610 may be simulated as a Butterworth filter having a corner frequency of 5 MHz, although this disclosure is not limited thereto.

On the other hand, at the circuit design stage, the test system may also execute a virtual code via the aforementioned circuit simulation tool to sequentially set the low-frequency equalizer coefficients b₀, b₁, and a₁ (or the low-frequency equalizer coefficients b₀ and a₁) to different values (or different value combinations). In some embodiments, the virtual code may be MATLAB code, and its script may be as follows:

```
FOR G = 100: 25: 800
  FOR ω_{c} = 0.0005: 0.0005: 0.02
    Initialize parameters
    Establish 1000BASE-T Ethernet connection
  WHILE the 1000BASE-T Ethernet connection is in training phase
    Idle
  END WHILE
    Record the sum of absolute values of the decision feedback equalizer
    coefficients
    Record the signal-to-noise ratio
    Terminate the 1000BASE-T Ethernet connection
  END FOR
END FOR
```

Where G is the aforementioned gain of the low-frequency equalizer circuit 131, and its value may be sequentially adjusted from 100 to 800 (with a step size of 25), and ω_{c} is the aforementioned corner frequency of the low-frequency equalizer circuit 131, and its value may be sequentially adjusted from 0.0005 MHz to 0.02 MHz (with a step size of 0.0005 MHz), and the 1000BASE-T Ethernet connection is the aforementioned network connection. Through multiple loops of the above virtual code, the gain G and the corner frequency ω_{c} of the low-frequency equalizer circuit 131 may be sequentially updated, thereby updating the low-frequency equalizer coefficients and accordingly recording the corresponding sum of absolute values of the decision feedback equalizer coefficients and the signal-to-noise ratio.

FIG. 7 illustrates a schematic diagram of a test system 700 for the method 400 for determining equalizer coefficients of FIG. 4 according to some embodiments of this disclosure. At a chip measurement stage, the test system 700 may include a chip testing machine 701, an input/output interface 702, an input/output interface 703, a link partner device 704, a physical network cable 705, and a device-under-test (DUT) chip 706. In some embodiments, the link partner device 704 may be a transmitter chip or a network communication chip. In some embodiments, the physical network cable 705 may be a twisted pair. The DUT chip 706 may be a communication chip including the receiver 100 of FIG. 1A.

The DUT chip 706 may be connected to the link partner device 704 via the physical network cable 705. In addition, the chip testing machine 701 may be connected to the link partner device 704 via the input/output interface 702 to output related test instructions (e.g., instructions corresponding to the operations in FIG. 4) to the link partner device 704, so that the link partner device 704 may establish a network connection with the DUT chip 706 via the physical network cable 705. Furthermore, the chip testing machine 701 may be connected to the DUT chip 706 via the input/output interface 703 to receive test results returned by the DUT chip 706 (e.g., the aforementioned sum of absolute values of the decision feedback equalizer coefficients and the signal-to-noise ratio). In this way, the chip testing machine 701 may analyze the test results returned by the DUT chip 706 and accordingly set the low-frequency equalizer coefficients (e.g., operations S405 and S406).

By establishing an actual chip operating environment, the test system 700 may further obtain optimal low-frequency equalizer coefficients corresponding to different network cable lengths, and store these coefficients in a memory (not shown) within the DUT chip 706. As a result, in subsequent applications, the DUT chip 706 may estimate the current cable length of the environment with channel estimation technique(s) and select a corresponding value of the low-frequency equalizer coefficients from these stored coefficients according to the cable length, thereby achieving better connection quality.

As described above, the equalizer coefficient determination method provided in some embodiments of this disclosure may, at a circuit design stage and/or a chip measurement stage, determine appropriate low-frequency equalizer coefficients based on a sum of absolute values of decision feedback equalizer coefficients and a signal-to-noise ratio, so as to compensate for the influence of a DC isolation circuit in a signal transmission path while simultaneously reducing the risk of error propagation and decision errors, thereby achieving better connection quality.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely some embodiments of the present disclosure, without any intention to limit the scope of the present disclosure thereto. Various equivalent changes, alterations, or modifications according to the claims of present disclosure are all consequently viewed as being embraced by the scope of the present disclosure.

What is claimed is:

1. A method for determining equalizer coefficients, executed by a test system, the method for determining the equalizer coefficients comprising the following operations:
(a) setting a plurality of low-frequency equalizer coefficients of a low-frequency equalizer circuit;
(b) establishing a network connection via the low-frequency equalizer circuit and a decision feedback equalizer circuit, wherein the decision feedback equalizer circuit operates according to an output of the low-frequency equalizer circuit;
(c) recording a sum of absolute values of a plurality of decision feedback equalizer coefficients of the decision feedback equalizer circuit and a signal-to-noise ratio;
(d) repeatedly performing the operations (a) to (c) to obtain a plurality of sums of absolute values and a plurality of signal-to-noise ratios;
(e) selecting a first sum of absolute values from the plurality of sums of absolute values according to a predetermined threshold value and the plurality of signal-to-noise ratios; and
(f) setting the plurality of low-frequency equalizer coefficients as a value combination corresponding to the first sum of absolute values.

2. The method for determining equalizer coefficients of claim 1, wherein the operation (a) comprises:
setting a gain of the low-frequency equalizer circuit;
setting a corner frequency of the low-frequency equalizer circuit; and
setting the plurality of low-frequency equalizer coefficients as a first coefficient combination according to the gain and the corner frequency.

3. The method for determining equalizer coefficients of claim 1, wherein the operation (e) comprises:
selecting at least one second sum of absolute values from the plurality of sums of absolute values that is not greater than the predetermined threshold value; and
selecting the first sum of absolute values from the at least one second sum of absolute values according to the plurality of signal-to-noise ratios, wherein the first sum of absolute values is one having a highest signal-to-noise ratio in the at least one second sum of absolute values.

4. The method for determining equalizer coefficients of claim 1, wherein the operations (a) to (f) are executed at a circuit design stage by executing a virtual code via the test system.

5. The method for determining equalizer coefficients of claim 4, wherein the virtual code is configured to sequentially set the plurality of low-frequency equalizer coefficients to different value combinations.

6. The method for determining equalizer coefficients of claim 1, wherein the operation (b) comprises:
transmitting an input signal to the low-frequency equalizer circuit via an electrical isolation model to establish the network connection.

7. The method for determining equalizer coefficients of claim 6, wherein the electrical isolation model operates as a DC isolation circuit.

8. The method for determining equalizer coefficients of claim 6, wherein the electrical isolation model operates as a high-pass filter circuit.

9. The method for determining equalizer coefficients of claim 1, wherein the operations (a) to (f) are executed at a chip measurement stage.

10. The method for determining equalizer coefficients of claim 1, wherein the operation (b) comprises:
connecting a device-under-test chip to a link partner device via a physical network cable to establish the network connection,
wherein the device-under-test chip comprises the low-frequency equalizer circuit and the decision feedback equalizer circuit.

11. The method for determining equalizer coefficients of claim 1, wherein the operation (d) comprises:
recording the plurality of sums of absolute values and the plurality of signal-to-noise ratios respectively as two sets of heat map data.

12. The method for determining equalizer coefficients of claim 1, wherein the low-frequency equalizer circuit is a shelving filter circuit.

13. The method for determining equalizer coefficients of claim 1, wherein the low-frequency equalizer circuit comprises:
a first subtractor circuit configured to subtract a fifth signal from a digital signal to generate a first signal, wherein the digital signal is generated based on an input signal;
a first multiplier circuit configured to multiply the first signal by a first coefficient of the plurality of low-frequency equalizer coefficients to generate a second signal;
a second adder circuit configured to add the second signal and a fourth signal, wherein a sum of the second signal and the fourth signal is the output of the low-frequency equalizer circuit;
a delay circuit configured to delay the first signal to generate a third signal;
a second multiplier circuit configured to multiply the third signal by a second coefficient of the plurality of low-frequency equalizer coefficients to generate the fourth signal; and
a third multiplier circuit configured to multiply the third signal by a third coefficient of the plurality of low-frequency equalizer coefficients to generate the fifth signal.

14. The method for determining equalizer coefficients of claim 1, wherein the low-frequency equalizer circuit comprises:
a first adder circuit configured to add a digital signal and a seventh signal to generate a first signal, wherein the digital signal is generated based on an input signal;
a first multiplier circuit configured to multiply the first signal by a first coefficient of the plurality of low-frequency equalizer coefficients to generate a second signal;
a second adder circuit, configured to add the second signal and a sixth signal, wherein a sum of the second signal and a fourth signal is the output of the low-frequency equalizer circuit;
a first delay circuit configured to delay the first signal to generate a third signal;
a second delay circuit configured to delay the second signal to generate the fourth signal;
a third adder circuit configured to add the third signal and a fifth signal to generate the sixth signal;
a subtractor circuit configured to subtract the third signal from the seventh signal to generate the fifth signal; and
a second multiplier circuit configured to multiply the third signal by a second coefficient of the plurality of low-frequency equalizer coefficients to generate the seventh signal.
